(19) United States
(12) Patent Application Publication
(10) Pub. No.: US 2013/0286027 A1
(43) Pub. Date: Oct. 31, 2013

(54) GRAPHICS TO UNIVERSAL SERIAL BUS CONVERSION

(71) Applicants: Bernard D. Desselle, Spring, TX (US); Robert C. Brooks, Houston, TX (US)

(72) Inventors: Bernard D. Desselle, Spring, TX (US); Robert C. Brooks, Houston, TX (US)

(21) Appl. No.: 13/459,317

(22) Filed: Apr. 30, 2012

(51) Int. Cl. G06F 13/14

(52) U.S. Cl. 345/520

(57) ABSTRACT

Example embodiments disclosed herein relate to conversion of a graphics signal to a Universal Serial Bus (USB) signal to be outputted to a USB visual presentation device or display device. The graphics signal is received via a graphics port. The graphics signal is converted to a USB signal. The USB signal is output to the USB visual presentation device or display device.

### BACKGROUND

Universal Serial Bus (USB) monitors are being sold worldwide. USB monitors can receive a USB signal from a computing device to present output. These USB monitors can be used, for example, as a secondary monitor for a computing device.

### BRIEF DESCRIPTION OF THE DRAWINGS

The following detailed description references the drawings, wherein:

FIG. 1 is a block diagram of a computing system including a graphics converter to convert a graphics input into a Universal Serial Bus output, according to one example;

FIG. 2 is a block diagram of a graphics converter device, according to one example;

FIG. 3 is a flowchart of a method for receiving and converting a graphics signal to a Universal Serial Bus signal and outputting the Universal Serial Bus signal, according to one example; and

FIG. 4 is a flowchart of a method for notifying a computing device about a resolution associated with a display device, according to one example.

### DETAILED DESCRIPTION

As noted above, Universal Serial Bus (USB) monitors are becoming popular in the marketplace. However, USB monitors are generally used as secondary monitors for computing devices. This is because USB monitors do not display content until an Operating System (OS) loads USB drivers. As such, video output of the computing device during Power-On Self-Test (POST) loaded by a Basic Input/Output System (BIOS) or loading of the OS before USB drivers are loaded cannot be seen on the USB monitor. With additional work on customizing a system, the BIOS could eventually include this function thereby allowing video output to be displayed before the OS loads. However, in order for a USB monitor to behave consistently with multiple different products, all of the major vendors of video controllers would be required to get this support into the BIOS. This support would also need to be incorporated into the video BIOS, which may be integrated into the System BIOS for both onboard Video and the video BIOS of graphics cards.

Accordingly, various embodiments disclosed herein relate to a graphics to USB converter device that can receive input from a graphics interface, such as a Video Graphics Array (VGA), Digital Visual Interface (DVI), High-Definition Multimedia Interface (HDMI), DisplayPort, etc. These graphics interfaces can conform to one or more standards and/or specifications, for example, the Video Electronics Standard Association (VESA) Display Information Format (VDIF), the Extended Display Identification Data (EDID) standard, etc. A conversion module can be used to convert the graphics signal received into a USB signal. The graphics signal can be implemented using a specification and/or technology that are not a USB signal. The output of the device can be USB. With this approach, video out from the graphics interface of the computing device would connect to the graphics to USB converter device. The USB output of the graphics to USB converter device would be connected to a USB display device, such as a USB monitor. Circuitry of the device can convert the received graphics to a USB format and send the USB graphics data to the USB display device. Also, because the graphics to USB converter device does not depend on a particular OS or software running on the host device, the USB monitor can be used as a primary display. To the USB monitor, the USB converter device can seem like a host device. The USB converter device can include instructions to drive the USB monitor like a host device and/or communicate with the USB monitor as a host device.

In certain embodiments, USB is a specification that describes communications protocols used in a bus for connection, communication, and power supply between electronic devices. In certain examples, USB can refer to one or more industry standards, for example, USB 1.0, USB 1.1, USB 2.0, and/or USB 3.0.

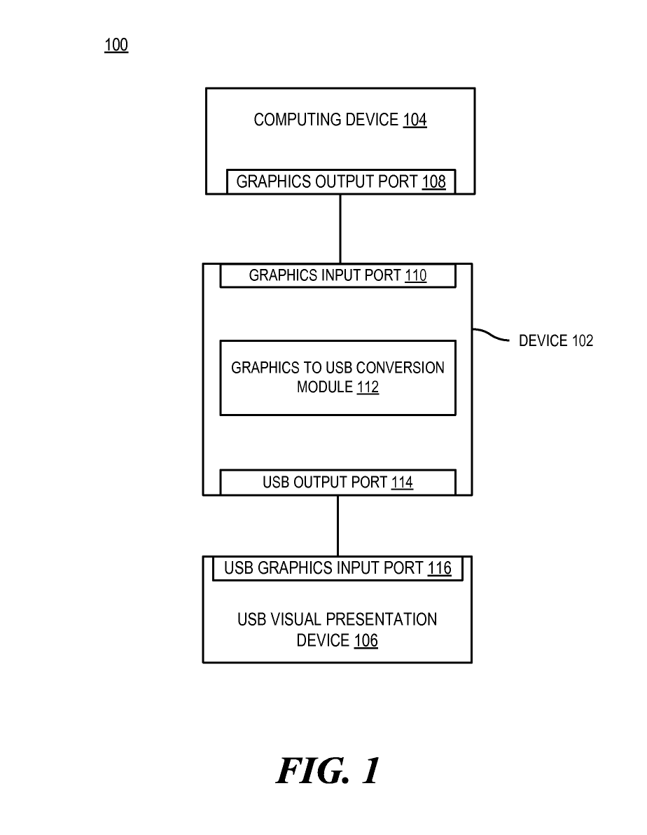

FIG. 1 is a block diagram of a computing system including a graphics converter to convert a graphics input into a Universal Serial Bus output, according to one example. The system 100 can include a device 102 that can be connected to a computing device 104 and a USB visual presentation device 106. In one example, a graphics output port 108 of the computing device 104 can be connected to a graphics input port 110 of the device 102. A graphics to USB conversion module 112 can convert the signal to USB and a USB output port 114 of the device 102 can output the USB signal to a USB graphics input port 116 of the USB visual presentation device 106. In certain embodiments, the device 102 can be implemented via a processing element, memory, and/or other components.

The graphics input port 110 of the device 102 can receive a graphics signal from the computing device 104. In one example, the graphics input port 110 can support one of various graphics technologies, for example, the graphics input port 110 can include at least one of a VGA port, a Super VGA (SVGA) port, a DVI port, an HDMI port, and a DisplayPort port. Further, in certain scenarios, the graphics input port 110 can be compatible with multiple inputs and/or the device 102 can have multiple graphics input ports associated with different graphics technologies. The graphics output port 108 of the computing device 104 can output graphics information compatible with the graphics input port 110. As such, in some examples, the graphics signal received can be one of VGA, DVI, HDMI, and DisplayPort.

The graphics to USB conversion module 112 can convert the graphics signal to a USB signal capable of driving the USB visual presentation device 106. In certain examples, the USB signal is received at the USB graphics input port 116 and the USB visual presentation device 106 drives a display based on the received USB signal. For example, the USB signal can be used to send information to fill a buffer or memory that can then be used to cause an image to appear on the display. In certain examples, the display can be a monitor while in other examples; the display can be a screen (e.g., a Liquid Crystal Display (LCD) screen) that may be used to project the image.

The USB output port 114 can then be used to provide the USB signal to the USB visual presentation device 106. The USB visual presentation device 106 can receive the USB signal and drive a display or monitor, such as an LCD monitor, a cathode ray tube (CRT), an organic light-emitting diode (OLED), etc. based on the USB signal. In one example, the USB signal can be used to fill a buffer that is used to control a matrix of transistors, for example, thin-film transistors (TFTs). In the example of an LCD monitor, a matrix of TFTs can be added to electrodes in contact with a liquid crystal layer. Each pixel can have a dedicated transistor. The matrix of TFTs can be used to control images presented on the monitor. As such, each column, row coordinate of the matrix can control a pixel. The information received from the USB signal can correspond to voltages to create a picture on the monitor.

In one example, the monitor can use an active matrix structure. In another example, the monitor can use a passive matrix structure. Active and passive matrices are types of addressing schemes used for flat panel displays. In an active matrix approach, each pixel is attached to a switch device (e.g., a TFT) that actively maintains the pixel state while other pixels are being addressed. In one example, a row or a set of rows of the matrix can be addressed at a time. As such, a first row can be addressed and activated, and then the row is actively maintained while this row is deactivated. Then, the next row can be addressed and activated.

In some examples, the USB signal can be processed to drive the active matrix of the USB visual presentation device 106 by providing information to a timing controller (TCON) used to drive the active matrix. The timing controller can determine the timing of image signals and in turn transmits the signals to a TFT LCD driver integrated circuit, which enables images to be displayed on a TFT LCD panel.

In other examples, the USB signal can be used to directly drive the active matrix of the monitor. As such, the USB signal can be used to control a TFT LCD driver integrated circuit to enable images being displayed. Further, the USB signal can conform to a standard or specification used to control USB monitors. For example, the USB signal can conform to the USB Monitor Control interface.

The device 102 can be implemented as a device external to a computing device. Further, the device can be a graphics converter device that can take the form of a dongle that can be attached to the computing device via a graphics port and provide a USB signal to drive the USB visual presentation device 106. In certain embodiments, a graphics to USB dongle is a device that enables a USB visual presentation device 106 to be driven.

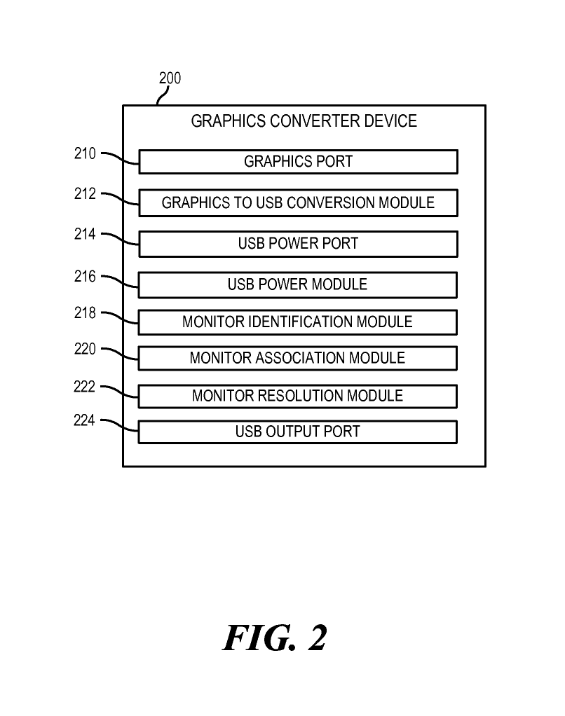

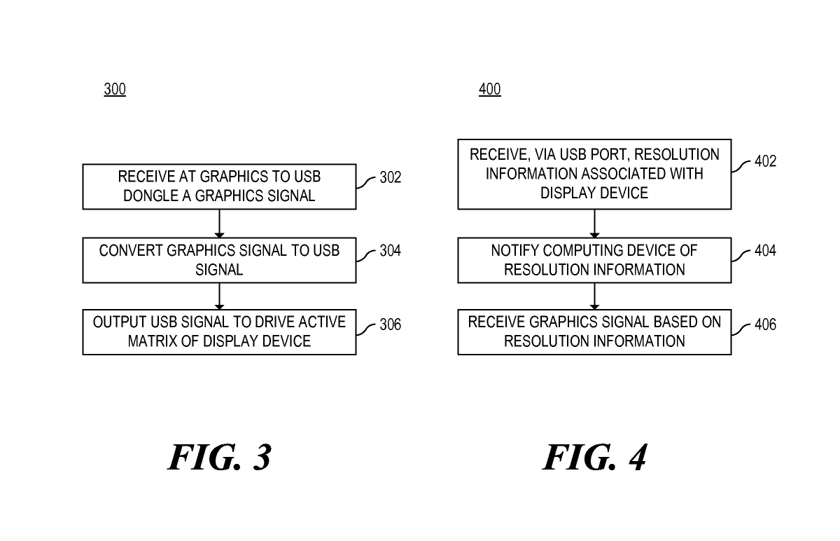

FIG. 2 is a block diagram of a graphics converter device, according to one example. In this example, the graphics converter device 200 includes a graphics port 210, a graphics to USB conversion module 212, a USB power port 214, a USB power module 216, a monitor identification module 218, a monitor association module 220, a monitor resolution module 222, and a USB output port 224. As detailed herein, graphics converter device 200 may be used to implement methods to provide a USB signal to drive a USB visual presentation device, for example, by performing the methods of FIGS. 3 and/or 4.

One or more of the modules 212, 218, 220, 222 can be implemented via a processor and instructions and/or electronic circuits, such as scalar ICs configured to perform the functionality of the modules 212, 218, 220, 222. Each of the modules 212, 218, 220, 222 may include, for example, hardware devices including electronic circuitry for implementing the functionality described herein. In addition or as an alternative, each module may be implemented as a series of instructions encoded on a machine-readable storage medium (not shown) of the graphics converter device 200 and executable by a processor. It should be noted that, in some embodiments, some modules are implemented as hardware devices, while other modules are implemented as executable instructions or a combination thereof.

The graphics port 210 can receive a graphics signal from a computing device. As noted above, the graphics signal can be VGA, HDMI, DVI, or based on another video transmission technology. As such, the graphics port 210 can be a VGA port, another type of digital display interface such as DVI, HDMI, DisplayPort, etc., or the like.

The graphics to USB conversion module 212 can convert the graphics signal to a USB signal. The conversion can be based on the information received via the graphics port 210 and/or from a USB visual presentation device, such as a monitor, attached to the USB output port 224.

In one example, the monitor resolution module 222 can receive resolution information, via the USB output port 224, about one or more resolutions that is associated with the monitor, such as a native resolution and/or compatible resolutions. The graphics port 210 can be used by the monitor resolution module 222 to transmit the resolution information to the computing device, for example, via the technology used to connect the graphics port 210.

As such, a graphics card, adapter, or other circuitry (e.g., a Display Data Channel (DDC)) of the computing device can be notified of the resolution information and can process the resolution information to determine the graphics signal output from the computing device by setting a resolution for the graphics signal output that is compatible and/or native to the monitor. For example, the graphics signal can be formed as a signal conveying information about a resolution compatible with the USB visual presentation device, such as the native resolution. The graphics signal can then be processed using the graphics to USB conversion module 212 to form the USB signal. As such, the USB signal can be based on the resolution information. Further, in certain examples, the resolution information may not be sent to the computing device, but instead, the graphics to USB conversion module 212 may convert the graphics signal to a compatible resolution.

In some examples, the USB output port 224 can also receive an identifier associated with the USB visual presentation device. A monitor identification module 218 can receive the identifier and associate the USB visual presentation device with a device and/or device type. The monitor association module 220 can then associate the device and/or device type with one or more parameters. These parameters can include, for example, compatible resolutions, refresh rates, etc. The monitor association module 220 can include, for example, a table used to associate identifiers with parameters. The conversion of the graphics signal to the USB signal can be based on these parameters. Further, in certain examples, the parameters can be sent to the computing device via the graphics port 210.

As such, the computing device can adjust the graphics signal based on the parameters. Moreover, in certain examples, the graphics to USB conversion module 212 may configure the USB signal conversion based on the parameters. In some examples, the parameters can include a driver associated with the identifier. For example, one approach to driving a USB monitor can be used when associated with a first identifier and a second approach to driving the USB monitor can be used if the USB monitor is associated with a second identifier. Driver information can be stored as part of the monitor association module 220 or otherwise stored on the graphics converter device 200.

The USB output port 224 can output the USB signal to the USB visual presentation device. As discussed in FIG. 1, the USB signal can be configured to drive an active matrix of the USB visual presentation device. The matrix can be driven directly, via a TCON board, or using other technology compatible with the USB visual presentation device.

In certain examples, the graphics converter device 200 can be powered via a power source. In one example, the power can come from a USB power port 214 that can be connected to the computing device and/or another power source. A USB power module 216 can be used to distribute the power to other modules of the graphics converter device 200. As such, the USB power module 216 can power the graphics converter device 200 via a connection to the USB power port 214. In other examples, the USB power port 214 may additionally be used to communicate with the computing device, for example, to upgrade firmware used to implement one or more parts of the graphics converter device 200. Other power sources can be used, such as a battery or external power from a wall outlet.

FIG. 3 is a flowchart of a method for receiving and converting a graphics signal to a Universal Serial Bus signal and outputting the Universal Serial Bus signal, according to one example. Although execution of method 300 is described below with reference to graphics converter device 200, other suitable components for execution of method 300 can be utilized (e.g., device 102). Method 300 may be implemented in the form of executable instructions stored on a machine-readable storage medium, and/or in the form of electronic circuitry.

A machine-readable storage medium may be any electronic, magnetic, optical, or other physical storage device that contains or stores executable instructions. Thus, machine-readable storage medium may be, for example, Random Access Memory (RAM), an Electrically Erasable Programmable Read-Only Memory (EEPROM), a storage drive, a Compact Disc Read Only Memory (CD-ROM), and the like. As such, the machine-readable storage medium can be non-transitory. As described in detail herein, a machine-readable storage medium may be encoded with a series of executable instructions for converting a graphics signal to a USB signal that can drive an active matrix of a display device. Further, the storage medium can be included in an integrated circuit that may include other hardware to more efficiently convert graphics signals to USB signals.

At 302, the graphics converter device 200 receives a graphics signal from a computing device via a graphics port 210. In certain scenarios, the graphics converter device 200 can be a graphics to USB dongle. As noted above, the graphics signal can be associated with a Digital Display Interface technology, VGA technology, or the like. In certain scenarios, Digital Display Interface technology is a digital technology used to connect a video source to a display device. Digital Display Interface technology can include, for example, DisplayPort technology, HDMI technology, DVI technology, etc. Further, the graphics port 210 can be one of a VGA port or a Digital Display Interface port that is compatible with at least one of the Digital Display Interface technologies.

At 304, the graphics to USB conversion module 212 can convert the graphics signal into a USB signal. The conversion can occur using a processor and/or using specialized hardware. Further, the processed USB signal can be used to drive a display. For example, the USB signal can be configured to a specification or standard. The specification and/or standard can correspond to driving an active matrix of a display device. As further detailed in FIG. 4, the output signal can also be configured based on information received from the display device receiving the USB signal.

The graphics converter device 200 can then output the USB signal to drive an active matrix of the display device via a USB output port 224 (at 306). The display device can receive the USB signal. Further, the display device can be driven by the USB signal as discussed above.

FIG. 4 is a flowchart of a method for notifying a computing device about a resolution associated with a display device, according to one example. Although execution of method 400 is described below with reference to graphics converter device 200, other suitable components for execution of method 400 can be utilized (e.g., device 102). Additionally, the components for executing the method 400 may be spread among multiple devices. Method 400 may be implemented in the form of executable instructions stored on a machine-readable storage medium, and/or in the form of electronic circuitry.

The graphics converter device 200 can be connected via a graphics port 210 to a computing device and via a USB output port 224 to a display device. The graphics converter device 200 can be powered via one of a plurality of power sources, for example, via a USB port, a battery, power from a power output, etc. When connected to the display device, the graphics converter device 200 can act as a host device that drives a display associated with the display device via a USB signal. The USB signal can be based on information received from the display device.

At 402, a monitor resolution module 222 can receive, via a USB port, information about a resolution associated with the display device. The resolution information can include details about a native resolution of the display device. Further, information about multiple resolutions can be received, for example, resolutions that the display device is compatible with.

The monitor resolution module 222 can notify the computing device of the supported resolutions via the graphics port 210 at 404. The computing device can configure a graphics signal that it outputs to the graphics port 210 based on the received resolution information. Then, at 406, the graphics to USB conversion module 212 can receive the graphics signal that is based on the resolution via the graphics port 210. The graphics signal can correspond to the resolution, or if multiple resolutions are sent to the computing device, the graphics signal can correspond to one of the resolutions. The graphics to USB conversion module 212 can then output the USB signal to drive the display device via the USB output port 224.

With the above approaches, USB monitors can be used as primary devices on computing devices. The graphics to USB device can support one or more popular graphics interfaces, for example VGA, DVI, HDMI, DisplayPort, etc. The output can be a USB signal that can be configured to drive one or more USB monitors. The graphics to USB device can further customize its output signal based on the USB monitor. As such, USB monitors of varying sizes and/or types can be supported. Further, with this approach, vendors of graphics cards and/or computing devices need not write BIOS code to support the various USB monitors on the market. Instead, the USB monitor is driven using a graphics signal that is converted to USB. This can help improve the marketability of the USB monitor because, with the graphics to USB conversion device, the USB monitor can be compatible as a primary device on existing systems.

What is claimed is:

1. A device comprising:
a graphics input port to receive a graphics signal from a computing device;
a graphics to Universal Serial Bus (USB) conversion module to convert the graphics signal to a USB signal capable of driving a USB visual presentation device; and
a USB output port to provide the USB signal to the USB visual presentation device.

2. The device of claim 1, wherein the USB visual presentation device includes a monitor and wherein the USB signal is configured to drive an active matrix of the monitor.

3. The device of claim 1, wherein the USB visual presentation device includes a monitor with a native resolution, the device further comprising:
a monitor resolution module to receive a representation of the native resolution from the monitor and to notify the computing device of the native resolution via the graphics input port.

4. The device of claim 3, further comprising:
monitor identification module to receive, via the USB output port, an identifier associated with the monitor; and
a monitor association module to associate a driver with the monitor, wherein the USB signal is based on the driver.

5. The device of claim 3, wherein the native resolution is used to determine the USB signal.

6. The device of claim 1, wherein the graphics input port is one of: a Video Graphics Array port and a Digital Display Interface port.

7. The device of claim 1, wherein the device is a graphics to USB dongle.

8. The device of claim 7, further comprising:
a USB power port; and
a USB power module to power the device via a connection to the USB power port.

9. A method comprising:
receiving, at a graphics to Universal Serial Bus (USB) dongle, a graphics signal from a computing device via a graphics port;
converting the graphics signal into a USB signal; and
outputting the USB signal to drive an active matrix of a display device via a USB port.

10. The method of claim 9, further comprising:
receiving, via the USB port, resolution information associated with the display device; and
notifying the computing device of the resolution information,
wherein the received graphics signal is based on the resolution information.

11. The method of claim 9, wherein the graphics port is one of: a Video Graphics Array port and a Digital Display Interface port.

12. A graphics converter device comprising:
a graphics port to receive a graphics signal from a computing device;
a graphics to Universal Serial Bus (USB) conversion module to convert the graphics signal to a USB signal; and
a USB output port to drive, via the USB signal, an active matrix of a USB visual presentation device and to receive resolution information associated with the USB visual presentation device,
wherein the graphics port is used to transmit the resolution information to the computing device, and
wherein the USB signal is based on the resolution information.

13. The graphics converter device of claim 12,
wherein the USB output port is further used to receive an identifier associated with the USB visual presentation device, and
wherein the conversion of the USB signal is based on the identifier.

14. The graphics converter device of claim 12, wherein the graphics signal is based on one of: a Video Graphics Array port and a Digital Display Interface port.

15. The graphics converter device of claim 12, further comprising:
a USB input port; and
a USB power module to power the device via a connection to the USB input port.
